(19) United States
(12) Patent Application Publication
(10) Pub. No.: US 2008/0309258 A1
(43) Pub. Date: Dec. 18, 2008

(54) DRIVING METHOD AND CONTROL METHOD OF HOT CATHODE FLUORESCENT LAMP, AND ESTIMATION METHOD OF TEMPERATURE OF FILAMENT IN HOT CATHODE FLUORESCENT LAMP

(76) Inventor: Feng-Li Lin, Taipei County (TW)

Correspondence Address: BIRCH STEWART KOLASCH & BIRCH, PO BOX 747, FALLS CHURCH, VA, 22040-0747, US

(21) Appl. No.: 12/138,340

(22) Filed: Jun. 12, 2008

(30) Foreign Application Priority Data
Jun. 14, 2007 (TW) 096121560

(51) Int. Cl. H05B 37/02

(52) U.S. Cl. 315/309

(57) ABSTRACT

An estimation method of the temperature of the filaments in the hot cathode fluorescent lamp (HCFL) is cooperated with a driving circuit, which drives a filament so that the filament has a filament voltage and a filament current. The estimation method includes the steps of measuring the filament voltage and/or the filament current calculating an equivalent resistance of the filament in accordance with the filament voltage and the filament current, and estimating the temperature of the filament in accordance with the equivalent resistance. A control method and a driving method of the HCFL are also disclosed.

### CROSS REFERENCE TO RELATED APPLICATIONS

This Non-provisional application claims priority under 35 U.S.C. §119(a) on Patent Application No(s). 096121560 filed in Taiwan, Republic of China on Jun. 14, 2007, the entire contents of which are hereby incorporated by reference.

### BACKGROUND OF THE INVENTION

1. Field of Invention

The invention relates to a driving method and a control method of a lamp. More particularly, the invention relates to a driving method and a control method of a hot cathode fluorescent lamp (HCFL) and an estimation method of the temperature of the filaments in the HCFL.

2. Related Art

Regarding to the liquid crystal display (LCD), the backlight module thereof usually uses the cold cathode fluorescent lamp (CCFL), light emitting diode (LED) or flat fluorescent lamp (FFL) as its light source. Recently, the hot cathode fluorescent lamp (HCFL) is also used as the light source of the backlight module.

The fluorescent lamp is usually filled with a mercury vapor and argon or a low-pressure mixing gas including argon and neon. A fluorescent layer is coated on the inner surface of the fluorescent lamp, and a filament made of tungsten is disposed in the lamp. When the fluorescent lamp is powered on, the filament is heated and then releases electrons. The gases in the lamp are ionized to form plasma, which can enlarge the current in the lamp. Then, the electrons hit the mercury vapor so as to emit ultraviolet ray. When the ultraviolet ray irradiates the fluorescent layer on the inner surface of the lamp, the fluorescent layer can emit visible light.

The filament is a tungsten filament coated with an emitter. The emitter is usually composed of calcium and selenium and will decrease gradually as long as the using time of the lamp increases. Thus, when the using time of the lamp increases, the filament current must be decreased to prevent the overheating of the filament. However, there is no method to directly measure the temperature of the filament. The present solution is to define the curve of the variation of the filament current versus the using time according to a lot of experiments, but this method can not precisely control the temperature of the filament.

Therefore, it is an important subject to provide a method for precisely estimating the temperature of a filament and the driving and control methods that can be applied to the HCFL.

### SUMMARY OF THE INVENTION

In view of the foregoing, the invention is to provide a driving method and a control method of the HCFL and an estimation method of the temperature of a filament that can precisely estimate the temperature of the filament for the consequent controlling and driving of the HCFL.

To achieve the above, the invention discloses an estimation method of a temperature of a filament in a HCFL, which is cooperated with a driving circuit. The driving circuit drives the filament, and the filament has a filament voltage and a filament current. The estimation method includes the steps of measuring the filament voltage and/or the filament current, calculating an equivalent resistance of the filament in accordance with the filament voltage and the filament current, and estimating the temperature of the filament in accordance with the equivalent resistance.

In addition, the invention also discloses a control method of a HCFL, which is cooperated with a driving circuit. The driving circuit drives a filament of the HCFL, and the filament has a filament voltage and a filament current. The control method includes the steps of measuring the filament voltage and/or the filament current, calculating an equivalent resistance of the filament in accordance with the filament voltage and the filament current, and controlling the filament voltage and/or the filament current, so that the equivalent resistance of the filament is set within a predetermined range.

To achieve the above, the invention further discloses a driving method of a HCFL, which is cooperated with a driving circuit and a controller. The controller controls the driving circuit, and the driving circuit drives the HCFL. The driving method includes the steps of providing a driving power source for driving a filament of the HCFL, measuring a filament voltage and/or a filament current of the filament, calculating an equivalent resistance of the filament in accordance with the filament voltage and the filament current, and controlling a voltage or a current of the driving power source by the controller, so that the equivalent resistance of the filament is set within a predetermined range.

As mentioned above, the estimation method of the temperature of the filament in the HCFL according to the invention can estimate the equivalent resistance of the filament according to the filament current and filament voltage, which can be measured by the resistance and temperature of the metal conductor, after the lamp is preheated and turned on. Then, the temperature of the filament can be calculated in real-time according to the relationship between the temperature and the resistance. In addition, a proper range of the working temperature can be preset for calculating the corresponding voltage and current. Then, the temperature of the filament can be controlled in real-time by controlling the voltage and current of the filament. Compared with the prior art, the invention can be applied to the driving and controlling of the HCFL so as to precisely estimate the temperature of the filament and thus control the driving power source (voltage or current). Accordingly, the temperature of the filament can be adjusted, so that the using time of the HCFL can be extended.

### BRIEF DESCRIPTION OF THE DRAWINGS

The invention will become more fully understood, from the detailed description and accompanying drawings, which are given for illustration only, and thus are not limitative of the present invention, and wherein:

FIG. 1 is a schematic illustration of a conventional HCFL;

FIG. 2 is a flow chart of an estimation method of the temperature of the filament in the HCFL according to an embodiment of the invention;

FIG. 3 is a schematic diagram showing the relationship between the resistance and temperature of a common metal;

FIG. 4 is a flow chart of a control method of the HCFL according to the embodiment of the invention; and

FIG. 5 is a flow chart of a driving method of the HCFL according to the embodiment of the invention.

### DETAILED DESCRIPTION OF THE INVENTION

The present invention will be apparent from the following detailed description, which proceeds with reference to the accompanying drawings, wherein the same references relate to the same elements.

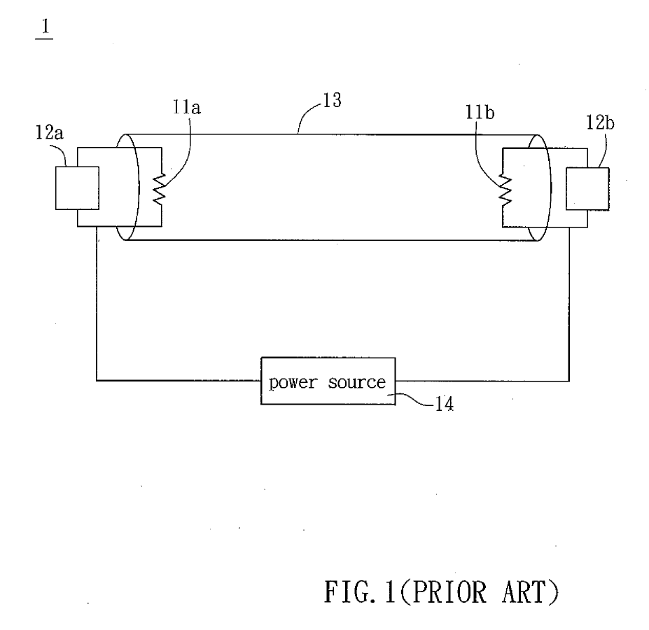

FIG. 1 is a schematic illustration of a conventional HCFL 1. Referring to FIG. 1, the HCFL 1 includes two filaments 11a and 11b, two driving circuit 12a and 12b, a lamp 13 and a power source 14. The filament 11a is electrically connected to the driving circuit 12a, and the driving circuit 12a drives the filament 11a. The filament 11b is electrically connected to the driving circuit 12b, and the driving circuit 12b drives the filament 11b. The lamp 13 is filled with mercury vapor, and a fluorescent layer is coated on the inner surface of the lamp 13. The power source 14 is an AC power source and is electrically connected to the filaments 11a and 11b.

The filaments 11a and 11b are disposed at two ends of the lamp 13, respectively. When the power source 14 applies voltage/current, the driving circuits 12a and 12b will control to heat the filaments 11a and 11b so as to release electrons. Then, the power source 14 starts to provide the work power source of the HCFL 1, so that the gas inside the lamp 13 is ionized to form plasma. This can increase the current (lamp current) in the lamp 13. Then, the electrons hit the mercury vapor to emit the ultraviolet light. When the ultraviolet light irradiates on the fluorescent layer on the inner surface of the lamp 13, the visible light can be generated. In general, after the lamp current is generated, the lamp is turned on and has passed the preheat procedure.

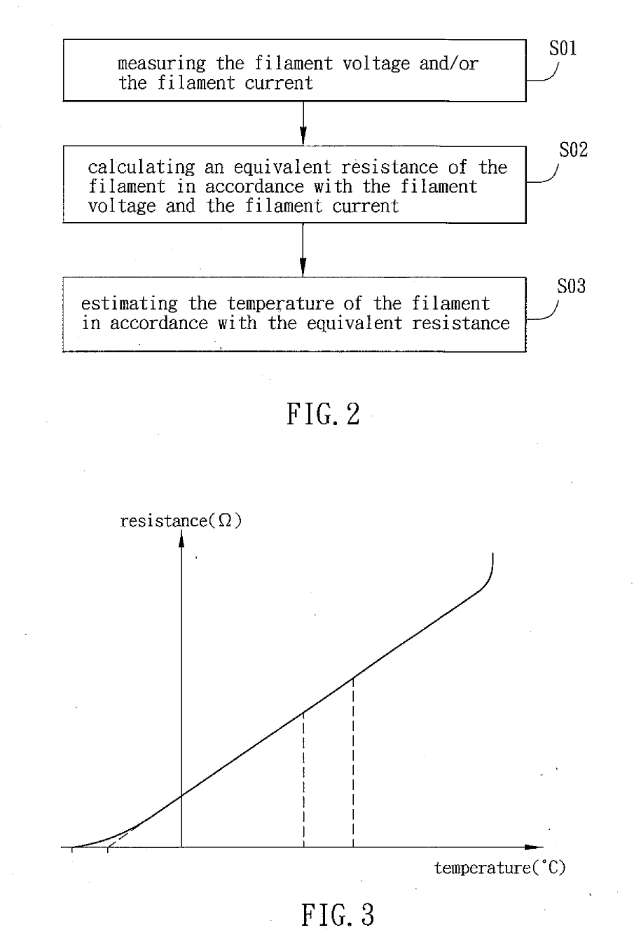

To make the invention more comprehensive, an estimation method of the temperature of the filament in the above-mentioned HCFL 1 will be described with reference to FIGS. 1 and 2. The estimation method includes the steps S01 to S03 and is cooperated with the driving circuit 12a or 12b. After the power source 14 turns on the HCFL 1 and the HCFL 1 is preheated, the driving circuit 12a drives the filament 11a or the driving circuit 12b drives the filament 11b. Accordingly, each filament has a filament voltage and a filament current.

The step S01 is to measure the filament voltage and/or the filament current.

The step S02 is to calculate an equivalent resistance of the filament 11a or 11b in accordance with the filament voltage and the filament current.

The step S03 is to estimate the temperature of the filament 11a or 11b in accordance with the equivalent resistance obtained in the step S02. The calculation can be digitally calculation performed by, for example, a micro-controller.

FIG. 3 is a schematic diagram showing the relationship between the resistance and temperature of a common metal. With reference to FIG. 3, since the resistance and temperature of metal have the relationship of direct proportion, the metal can have a resistance-temperature coefficient for representing the resistance variation under different temperatures. Herein, the resistance-temperature coefficient of metal can be represented by the following equation (1):

$${α}_{1} = \frac{{R}_{2} - {R}_{1}}{{R}_{1}} = \frac{Δ R}{{R}_{1}} \qquad ( 1 )$$

R₁: resistance at the temperature t

R₂: resistance at the temperature t+1

ΔR: R₂-R₁

α₁: resistance-temperature coefficient at the temperature t

According to the equation (1), the resistance at any temperature can be calculated as the following equation (2):

Rₓ=R₁+α₁(tₓ−t₁)×R₁=R₁[1+α₁(tₓ−t₁)] (2)

R₁: resistance at the temperature t₁

Rₓ: resistance at the temperature tₓ

α₁: resistance-temperature coefficient at the temperature t₁ and the resistance R₁

Assuming R₁ is the resistance of the metal tungsten at the temperature t₁, R₁ can be calculated according to the absolute temperature of the metal tungsten. Then, Rₓ can be calculated. It is known that the absolute temperature of the metal tungsten is −204° C. Thus, the relationship between the resistances Rₓ and R₁ of the tungsten filament at any temperature tₓ can be represented by the following equations (3) and (4):

$$\begin{matrix}\frac{{R}_{x}}{{t}_{x} - {t}_{0}} = \frac{{R}_{1}}{{t}_{1} - {t}_{0}} & ( 3 ) \\ {R}_{x} = {R}_{1} \times \frac{{t}_{x} - {t}_{0}}{{t}_{1} - {t}_{0}} = {R}_{1} \times \frac{{t}_{x} + 204}{{t}_{1} + 204} & ( 4 )\end{matrix}$$

Accordingly, the equivalent resistance of the filament 11a or 11b can be calculated according to the real-time measured filament voltage and filament current. Then, the temperature of the filament 11a or 11b can be calculated according to the equivalent resistance. In addition, to measure the filament voltage or the filament current, the driving circuit 12a or 12b can be drive the filament 11a or 11b by a voltage source or a current source. The filament voltage or the filament current can be measured during the periods that the HCFL 1 is turned on and turned off. Alternatively, after calculating the equivalent resistance, the temperature of the filament can be estimated by the table look-up method. In particular, the table look-up method can be used for the non-linear region between the temperature and resistance of the filament.

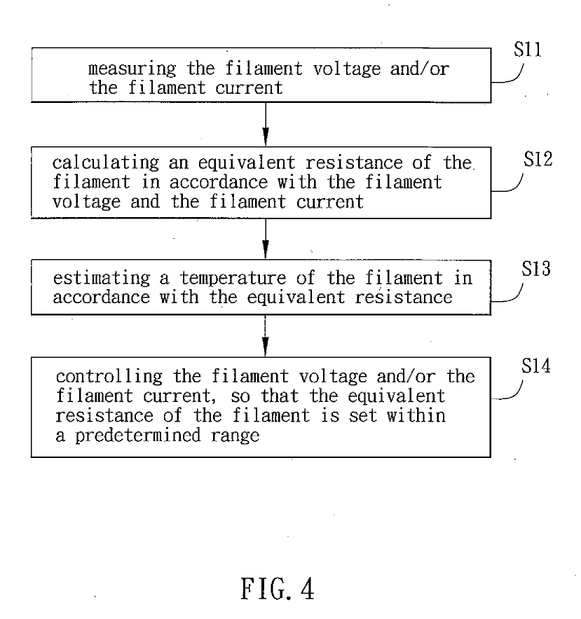

FIG. 4 is a flow chart of a control method of the HCFL according to the embodiment of the invention. The control method includes the steps S11 to S14, and is cooperated with the driving circuit 12a or 12b as shown in FIG. 1. When the power source 14 applies power to the HCFL 1 and the HCFL 1 is preheated and turned on, the driving circuit 12a drives the filament 11a of the HCFL 1 or the driving circuit 12b drives the filament 11b of the HCFL 1. Thus, the filament 11a or 11b has a filament voltage and a filament current.

The step S11 is to measure the filament voltage and/or the filament current.

The step S12 is to calculate an equivalent resistance of the filament in accordance with the filament voltage and the filament current.

The step S14 is to control the filament voltage and/or the filament current, so that the equivalent resistance of the filament is set within a predetermined range. For example, the predetermined range of the equivalent resistance corresponds to a filament temperature ranging from 700° C. to 1100° C. and preferably from 800° C. to 900° C.

The step S13 is to estimate a temperature of the filament 11a or 11b in accordance with the equivalent resistance. The steps S11 to S13 are similar to the steps S01 to S03 of the previously mentioned estimation method, so the detailed description will be omitted and only the step S14 will be described herein below.

Referring to equation (4), assuming that the resistance of the metal tungsten is R₁ as the temperature t₁ is the room temperature (26° C.), the resistance of the metal tungsten will be 4.5826×R₁ when the temperature is 850° C. According to this example, the temperature of the filament can be stably set within a predetermined range by presetting a temperature range corresponding to the resistance in accordance with the relationship between the resistance and temperature, followed by controlling the filament voltage and the filament current.

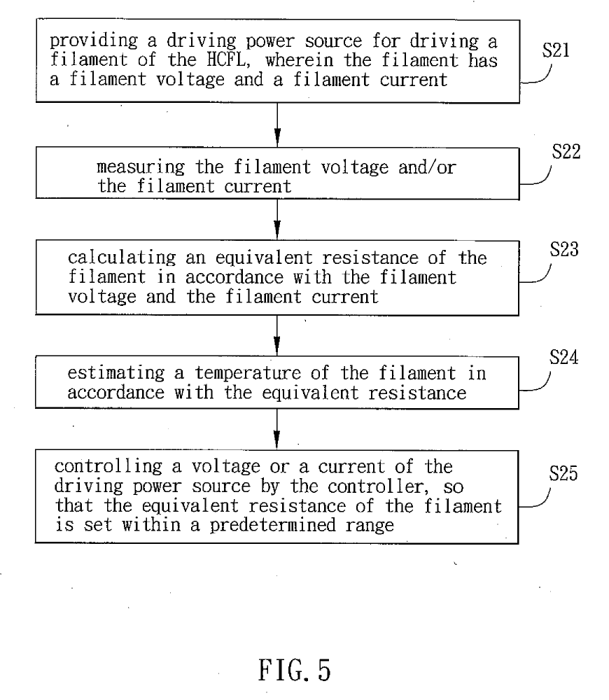

FIG. 5 is a flow chart of a driving method of the HCFL 1 according to the embodiment of the invention. The driving method includes the steps S21 to S25 and is cooperated with the driving circuit 12a or 12b and a controller (not shown). The controller controls the driving circuits 12a and 12b, and the driving circuit 12a or 12b drives the HCFL 1.

The step S21 is to provide a driving power source for driving a filament 11a or 11b of the HCFL 1. The filament 11a or 11b has a filament voltage and a filament current.

The step S22 is to measure the filament voltage and/or the filament current.

The step S23 is to calculate an equivalent resistance of the filament 11a or 11b in accordance with the filament voltage and the filament current.

In the step S25, the controller controls a voltage or a current of the driving power source, so that the equivalent resistance of the filament 11a or 11b is set within a predetermined range. For example, the predetermined range of the equivalent resistance corresponds to a filament temperature ranging from 700° C. to 1100° C. and preferably from 800° C. to 900° C.

In summary, the estimation method of the temperature of the filament in the HCFL according to the invention can estimate the equivalent resistance of the filament according to the filament current and filament voltage, which can be measured by the resistance and temperature of the metal conductor, after the lamp is preheated and turned on. Then, the temperature of the filament can be calculated in real-time according to the relationship between the temperature and the resistance. In addition, a proper range of the working temperature can be preset for calculating the corresponding voltage and current. Then, the temperature of the filament can be controlled in real-time by controlling the voltage and current of the filament. Compared with the prior art, the invention can be applied to the driving and controlling of the HCFL so as to precisely estimate the temperature of the filament and thus control the driving power source (voltage or current). Accordingly, the temperature of the filament can be adjusted, so that the using time of the HCFL can be extended.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An estimation method of a temperature of a filament in a hot cathode fluorescent lamp (HCFL), which is cooperated with a driving circuit, the driving circuit driving the filament and the filament having a filament voltage and a filament current, the estimation method comprising steps of:
measuring the filament voltage and/or the filament current;
calculating an equivalent resistance of the filament in accordance with the filament voltage and the filament current; and
estimating the temperature of the filament in accordance with the equivalent resistance.

2. The estimation method according to claim 1, wherein the temperature of the filament is estimated by a table look-up method.

3. The estimation method according to claim 1, wherein the driving circuit drives the filament by a voltage source or a current source.

4. A control method of a hot cathode fluorescent lamp (HCFL), which is cooperated with a driving circuit, the driving circuit driving a filament of the HCFL and the filament having a filament voltage and a filament current, the control method comprising steps of:
measuring the filament voltage and/or the filament current;
calculating an equivalent resistance of the filament in accordance with the filament voltage and the filament current; and
controlling the filament voltage and/or the filament current, so that the equivalent resistance of the filament is set within a predetermined range.

5. The control method according to claim 4, further comprising a step of:
estimating a temperature of the filament in accordance with the equivalent resistance.

6. The control method according to claim 5, wherein the temperature of the filament is estimated by a table look-up method.

7. The control method according to claim 4, wherein the driving circuit drives the filament by a voltage source or a current source.

8. The control method according to claim 4, wherein the predetermined range of the equivalent resistance corresponds to a filament temperature ranging from 700° C. to 1100° C.

9. A driving method of a hot cathode fluorescent lamp (HCFL), which is cooperated with a driving circuit and a controller, the controller controlling the driving circuit and the driving circuit driving the HCFL, the driving method comprising steps of:
providing a driving power source for driving a filament of the HCFL, wherein the filament has a filament voltage and a filament current;
measuring the filament voltage and/or the filament current;
calculating an equivalent resistance of the filament in accordance with the filament voltage and the filament current; and
controlling a voltage or a current of the driving power source by the controller, so that the equivalent resistance of the filament is set within a predetermined range.

10. The driving method according to claim 9, further comprising a step of:
estimating a temperature of the filament in accordance with the equivalent resistance.

11. The driving method according to claim 10, wherein the temperature of the filament is estimated by a table look-up method.

12. The driving method according to claim 9, wherein the driving circuit drives the filament by a voltage source or a current source.

13. The driving method according to claim 9, wherein the predetermined range of the equivalent resistance corresponds to a filament temperature ranging from 700° C. to 1100° C.
